(19) United States
(12) Patent Application Publication
(10) Pub. No.: US 2018/0349345 A1
(43) Pub. Date: Dec. 6, 2018

(54) REDUCING GRAPHICAL INTERFACE DESCRIPTION CODE

(71) Applicant: CA, Inc., New York, NY (US)

(72) Inventors: Austin Arlin Sand Walkup, Wellington, CO (US); Anthony Dewayne Scott, Fort Collins, CO (US)

(21) Appl. No.: 15/610,355

(22) Filed: May 31, 2017

(51) Int. Cl. G06F 17/27; G06F 17/24; G06F 9/44

(52) U.S. Cl. CPC G06F 17/272; G06F 8/38; G06F 17/245; G06F 17/248

(57) ABSTRACT

Systems, devices, and techniques for processing template code are disclosed herein. In some embodiments, template code that contains hierarchical levels of structure elements describing a display object is input to a pattern match program. The template code is parsed to determine an intra-level display property pattern for structure elements within at least one of the hierarchical levels. A prototype structure element is generated that includes the determined intra-level display property pattern. A template definition object that includes the prototype structure element and reduced template code is generated. The reduced template code includes at least one structure element that contains a reference to the prototype structure element. The reduced template code is expanded based on the reference to generate an expanded template object.

### BACKGROUND

The disclosure generally relates to the field of data processing, and more particularly to processing display template data structures.

Computer display objects are utilized in a wide variety of computing environments to leverage object display capability in a manner enhancing usability. One display object type, graphical user interfaces (GUIs), minimize the need for users to learn and utilize various complex computer program languages that would otherwise be required to execute commands using an underlying application program. For example, graphical interfaces are commonly an integral part of systems management code and utilized to enable a user to configure the underlying management code to select and manage various systems, devices, components, etc. The complexity of building and managing display objects may depend on the on the amount of (i.e., numbers of lines) and complexity (e.g., relational associations among code items) of the program code utilized to generate the interfaces.

### BRIEF DESCRIPTION OF THE DRAWINGS

Embodiments of the disclosure may be better understood by referencing the accompanying drawings.

FIG. 1 is a block diagram depicting a graphical interface processing system that reduces and expands graphical interface template code in accordance with some embodiments;

FIGS. 2A-2C illustrates a hierarchical XML template definition object represented as including expanded template code in accordance with some embodiments;

FIG. 2D is a block diagram depicting an XML tree representing hierarchically related markup language elements corresponding to the XML template definition implemented by the template definition object shown in FIGS. 2A-2C;

FIG. 2E illustrates a graphical interface display object generated by rendering the template document shown in FIGS. 2A-2C;

FIG. 3 is a flow diagram depicting operations and functions for reducing markup language graphical interface templates in accordance with some embodiments;

FIG. 4 is a flow diagram illustrating operations and functions for rendering expanded graphical interface template code in accordance with some embodiments; and

FIG. 5 is a block diagram depicting an example computer system that processes graphical interface template code in accordance with some embodiments.

### DESCRIPTION

The description that follows includes example systems, methods, techniques, and program flows that embody embodiments of the disclosure. However, it is understood that this disclosure may be practiced without some of these specific details. In other instances, well-known instruction instances, protocols, structures and techniques have not been shown in detail in order not to obfuscate the description.

### Overview

Disclosed herein are systems, devices, components, and techniques for reducing, expanding, and rendering display template code such as markup language descriptions of graphical interfaces or other graphical displays. In some aspects, a template object such as in the form of a markup language description is effectively compressed by identifying and categorizing multiple hierarchical levels of structure element display property patterns as well as overrides to the display patterns. In some embodiments, a markup language file/document is parsed to determine structural patterns among structure elements sharing a same hierarchical level within the markup language file. The structure elements may be generally characterized as designating, defining, or otherwise specifying the arrangement (i.e., absolute and/or relative positioning) of displayed objects within one or more fields in a graphical display. For instance, structural elements may include tables, columns, row, and cells that define the absolute and/or relative positioning of display elements such as individual fields and cells within a display object such as a GUI. Structure elements may also include containers, which may be generally characterized as wrappers that may include container-specific field definition(s) as well as incorporating (wrapping) sub-elements including other containers and tables.

Display property patterns and associated override properties are inserted as sub-elements or properties incorporated within or defined for members of a set of hierarchically related structure elements. For example, the display property patterns may be defined/specified for column elements that are incorporated within one or more prototype tables. Override properties associated with the display property patterns may be included in the prototype tables. Override properties may also be incorporated within other portions of a template definition object such as tables, columns, rows, and cells contained within reduced template code. The hierarchical relations and other relations among the structure elements may be defined by a markup language schema, such as a configuration file, in combination with element properties such as naming and attributes specified in the markup language data file itself. Having collected the repeated patterns and associated overrides within one or more prototype tables, the markup language file may be parsed to remove matching repeated instances of the patterns to generate a reduced code set that is associated with the prototype table(s) within a template definition object.

Hierarchical prototype definitions are utilized to compress template code into a reduced script. Overrides may be included in a prototype structure element itself as well as being hierarchically implemented via hierarchically related structural elements and sub-elements. The disclosed embodiments include techniques for regenerating an executable, expanded template object from the reduced template code. The reduced script is parsed to identify one or more compression prototype tables. For each prototype table, the constructs are regenerated by reference in the executable script.

As utilized herein, a structure element may refer, in part, to a template object element such as a markup language element that associates a graphical display field type (e.g., a column, row, cell) with an element name (e.g., column_1). Structure elements may be configured in a nested manner such that a parent structure element, such as a column or row, may include children structure elements (typically incorporated as sub-elements) such as cells that correspond to individual fields. Structure elements may be associated with properties that are direct attributes of or, more commonly, sub-elements of the structure elements. As utilized herein, the property elements/sub-elements specify a display characteristic (referred to herein alternatively as a display property) of the parent structure element. For example, a property element may comprise a data type, a pathname, a type, “value,” particular text string (e.g., a name), etc.

### Example Illustrations

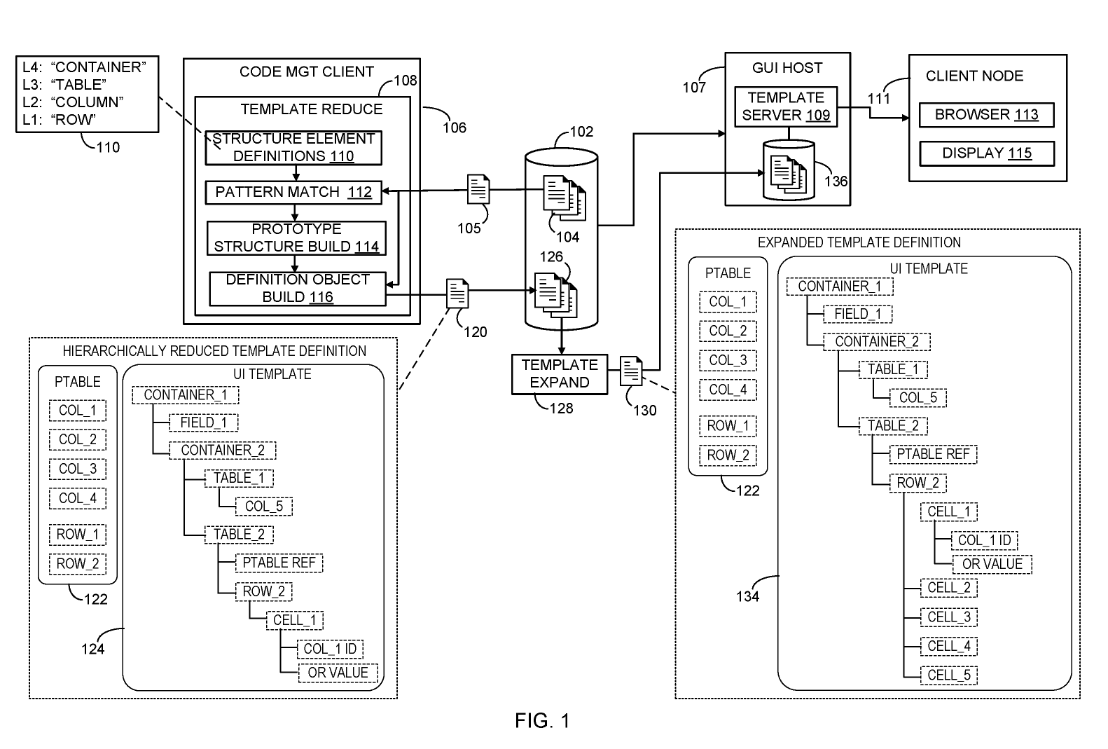

FIG. 1 is a block diagram depicting a template processing system that reduces, expands, and renders display template code in accordance with some embodiments. The system includes a code management application 106 and a graphical user interface (GUI) host 107 that are both communicatively coupled with a template storage system 102. Code management application 106 is executed from a computer platform (not depicted) and comprises program instructions and data for accessing and modifying template documents stored in storage system 102. GUI host 107 is configured, using any combination of coded software, firmware, and/or hardware to access template objects from template storage system 102 and to provide hosted access to the template documents such as to a client node 111. A template object generally refers to a distinctly identified/named set of template description code such as may be designated within a file.

Storage system 102 may include a server host configured, using any combination of coded software, firmware, and/or hardware, to store markup language files including original XML template files 104 that include XML descriptions of a graphical interface objects that may be displayed by a display program such as a browser. Template files 104 may include XML code that specifies one or more XML schemas that define elements for various GUI display objects. For instance, the XML code may include descriptions of various structure elements such as columns and rows that define the absolute or relative arrangement and positioning of field/cell elements that correspond to displayed fields within a GUI display object. The displayed objects are encoded as sub-elements of the structure elements. The displayed objects may include GUI control objects such as drop-down menus, text entries, text input fields, etc.

Storage system 102 is configured to respond to access requests from management application 106 by sending one or more template files, such as a template file 105, to management application 106. As depicted, management application 106 includes a template reduce application 108 that comprises program instructions and data for effectively compressing the XML code within XML template files such as template file 105. In addition to other code constructs, reduce application 108 includes a pattern match module 112 that processes the XML code within template file 105 in conjunction with structure element definitions 110 to identify or otherwise determine display property patterns. Template reduce application 108 includes program code for parsing the XML code within template file 105 based on structure element definitions 110 including CONTAINER, TABLE, COLUMN, and ROW. As illustrated, each of structure element definitions 110 includes or is otherwise associated with hierarchical levels L4, L3, L2, and L1, respectively.

As part of parsing the XML code, pattern match module 112 identifies display property patterns among structure elements within a same hierarchical level. For instance, the parsing by pattern match module 112 may include matching display property elements (e.g., text fields) and attributes among two or more column-type structure elements that are defined as within hierarchical level L2. Another aspect of the parsing performed by pattern match module 112 includes determining display property patterns among sub-elements (i.e., child elements) of a particular parent structure element having an associated structure element identifier (ID). For example, the parsing function of pattern match module 112 may be implemented by program code that matches display property attributes/values among sub-elements (e.g., fields) of a structure element (e.g., a column) having a specified ID.

Reduce application 108 further includes a prototype structure build module 114 that receives input from pattern match module 112. Structure build module 114 comprises program code and data for generating a prototype structure element that includes intra-level display property patterns (i.e., patterns within each of one or more hierarchical levels of structure elements) that have been identified or otherwise determined by pattern match module 112. For instance, pattern match module 112 may identify multiple instances of a field type pattern for each of multiple fields within a given column. In response, prototype structure build module 114 may generate a prototype table element comprising, in part, a column element that specifies the identified display property pattern.

Template reduce application 108 further includes a definition object build module 116 that receives as input template file 105 and one or more prototype structure elements from prototype structure build module 114. In some embodiment, template reduce application 108 generates a template definition object 120 that may be in the form of an XML file that includes and mutually associates the one or more prototype structure elements and a set of template code that is reduced from the set of code within template file 105. The reduced template code may comprise XML elements from template file 105 and one or more reference elements, each for a respective one of the one or more prototype structure elements. For example, definition object build module 116 generates template definition object 120 to include a prototype table 122 and reduced template code 124.

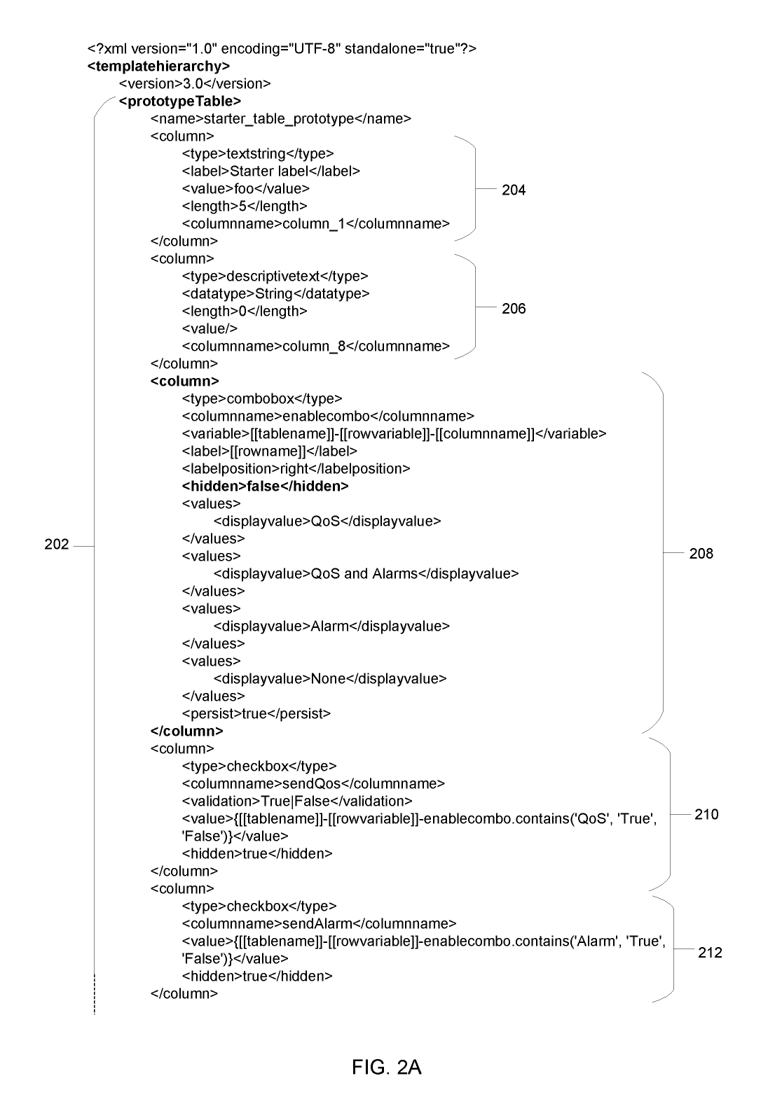

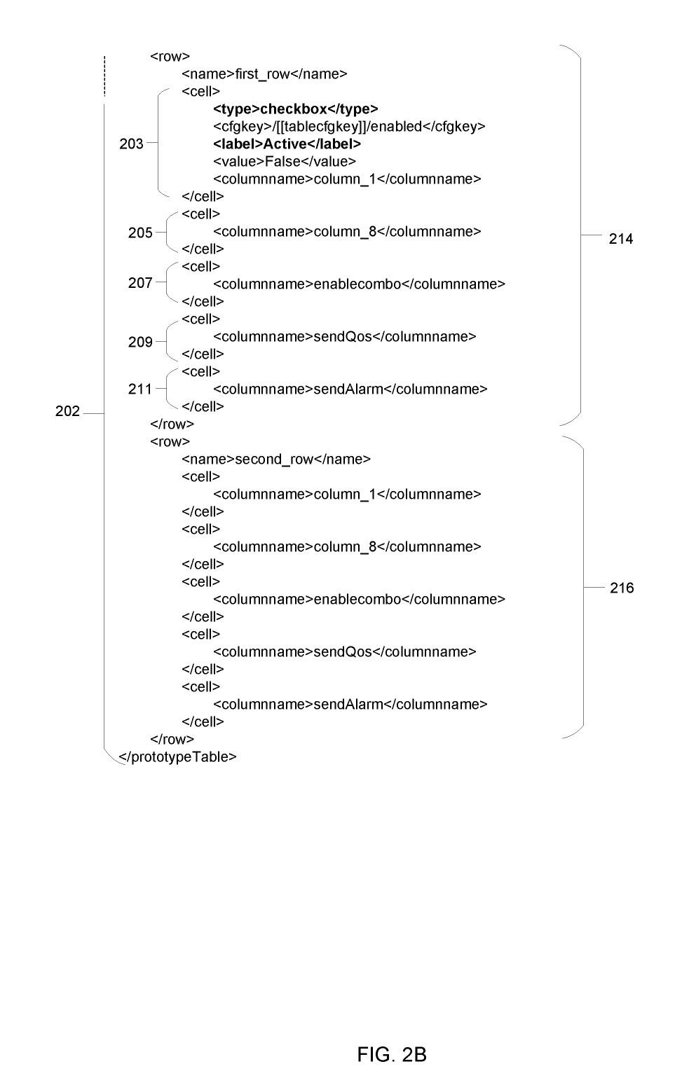

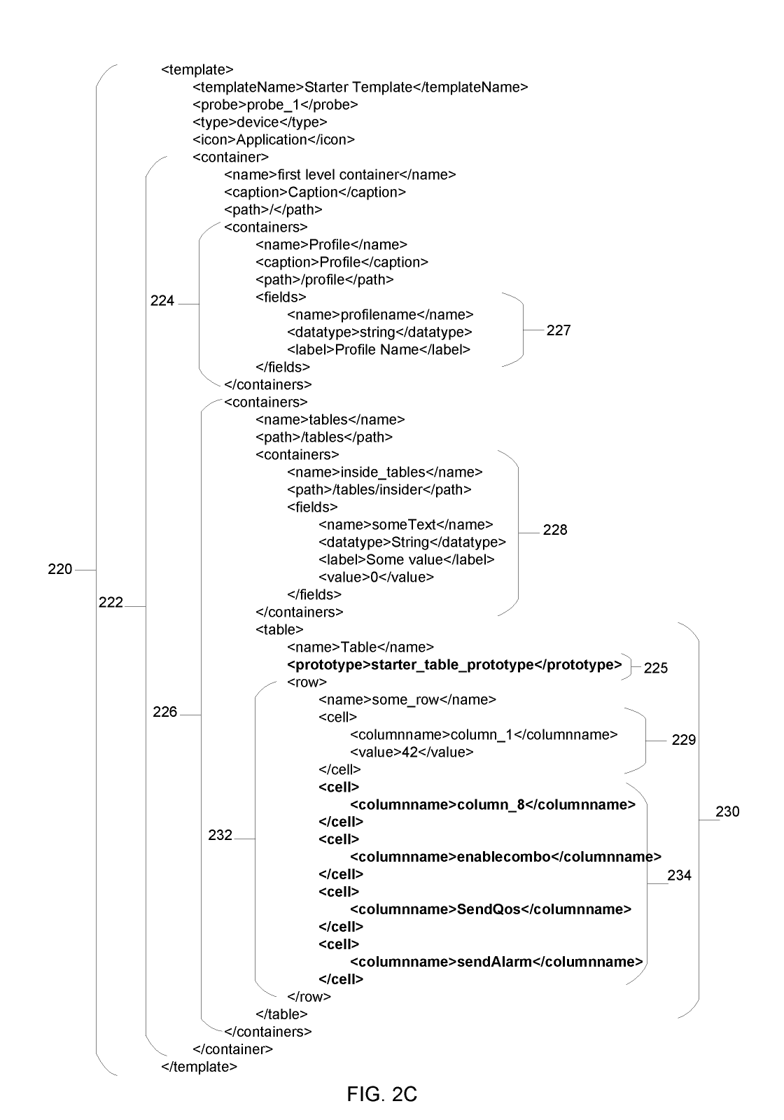

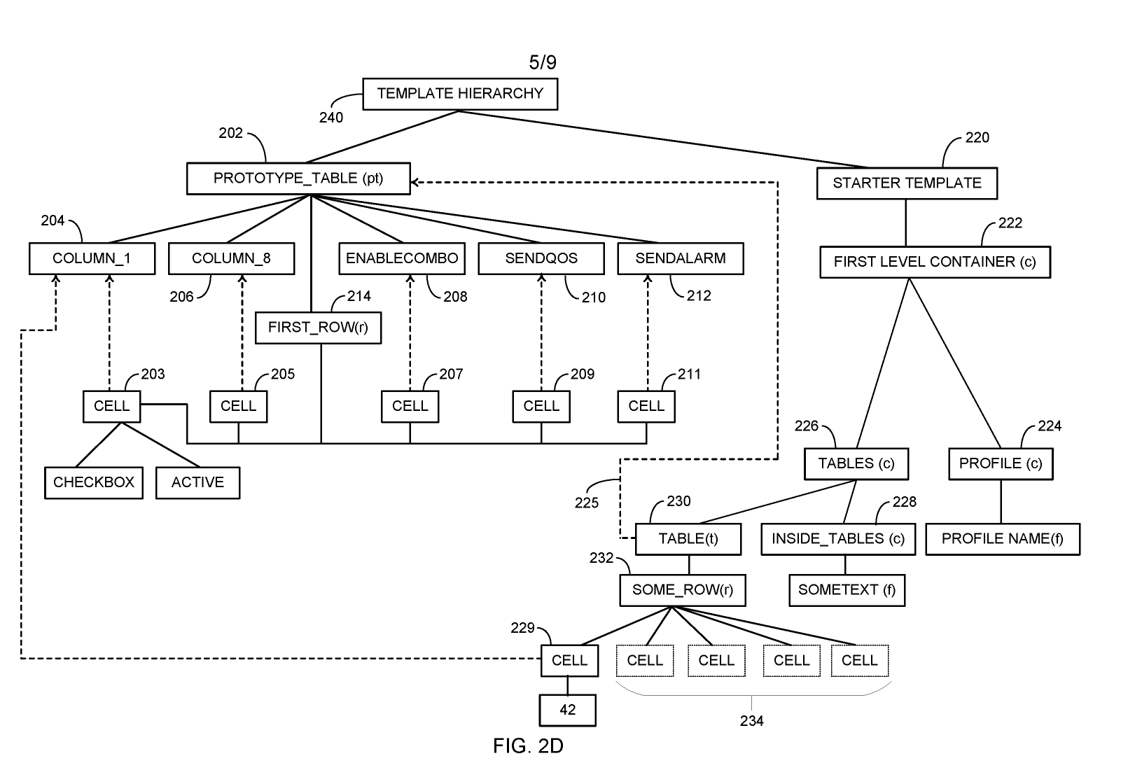

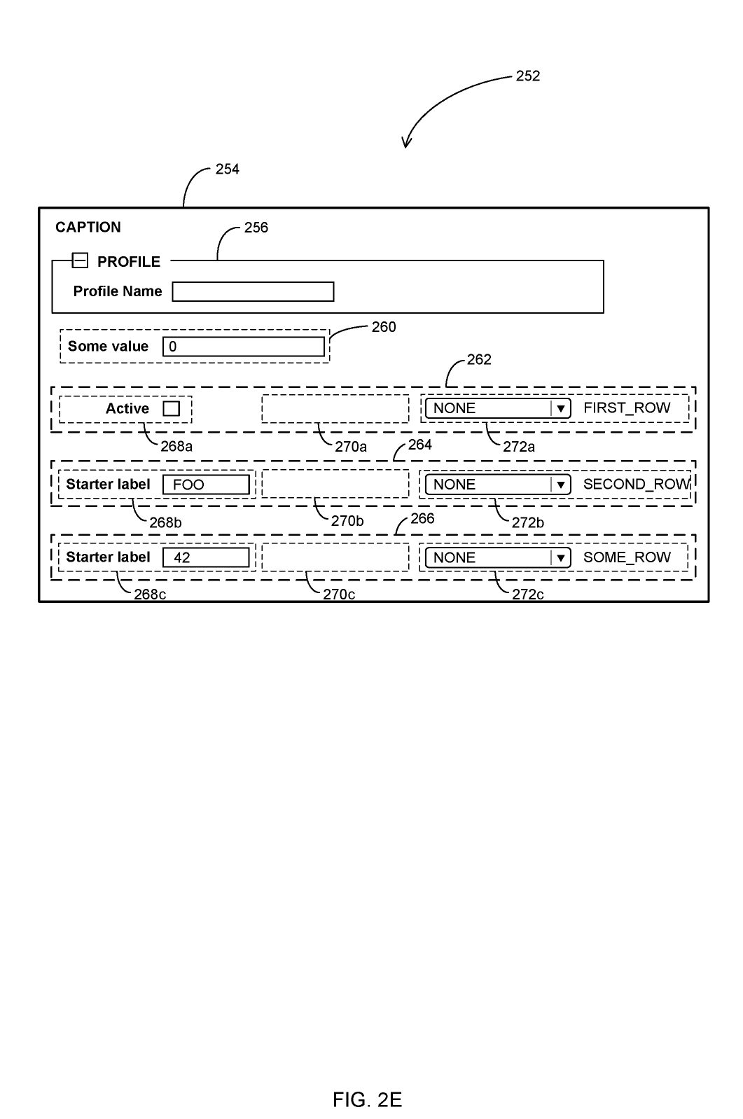

As illustrated, prototype table 122 is a parent structure element containing/comprising column sub-elements COL_1, COL_2, COL_3, and COL_4. Prototype table 122 further includes row sub-elements ROW_1 and ROW_2. As depicted and described in further detail with reference to FIGS. 2A-2E the parent-child relation between the column structure elements and row sub-elements may be implemented based on the column elements specifying associated field values in association with the column (parent) element name. The row elements specifying associated field values in association with the row (child) element name and the column (parent) element name. For instance, the column element COL_1 may include a text field value that is associated within the column element itself with an identifier element “COL_1” and the row element ROW_1 may include a text field value that is associated within the row element with an identifier “ROW_1” and also with the column identifier “COL_1.”

UI template 124 includes multiple XML elements including container, table, column, row, and field elements. As shown, UI template 124 comprises a root container element CONTAINER_1 that includes a field element FIELD_1 and a container element CONTAINER_2. The inclusion of sub-elements (e.g., FIELD_1 and CONTAINER_2) within an element (e.g., CONTAINER_1) is another implementation of relative hierarchy among structure and other XML elements within an XML document. As further depicted, the CONTAINER_2 element includes two tables, TABLE_1 and TABLE_2. The TABLE_1 element includes a column element, COL_5 and the TABLE_2 element includes a prototype reference element, PTABLE REF, and row element, ROW_2.

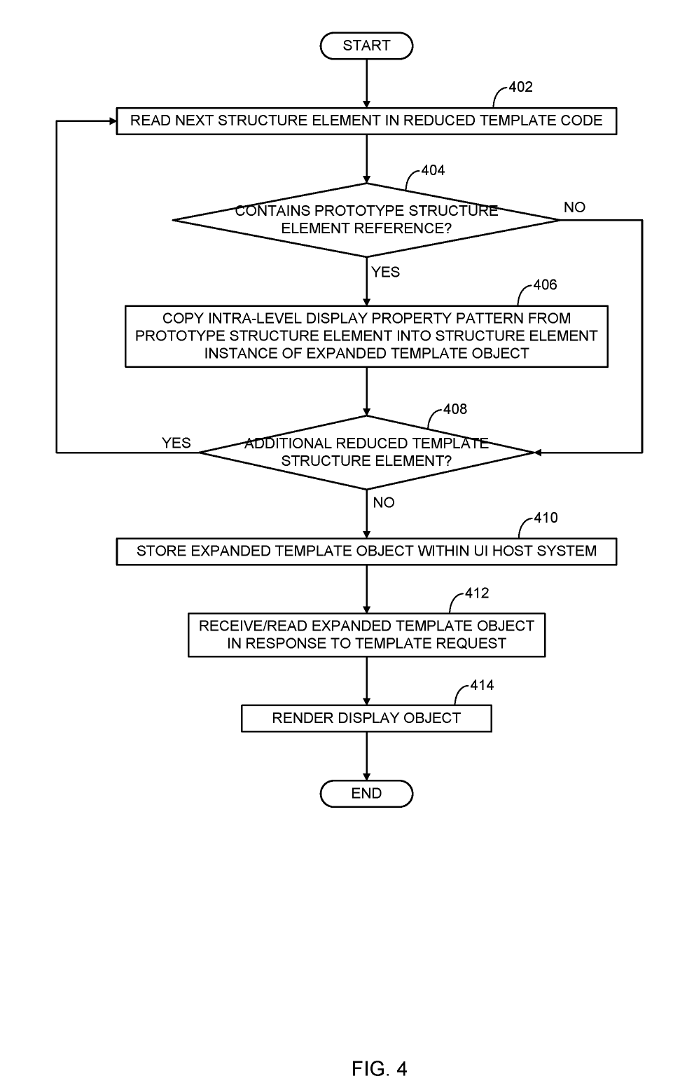

As depicted and described in further detail with reference to FIGS. 2C, 2D, and 4, the PTABLE REF element is processed by template expansion code, such as a template expand application 128 to re-insert XML display elements that were removed from the original XML template file 105 to produce the reduced template portion of reduced template definition object 120. For instance, reduced template definition object 120 may be transmitted to and stored in storage system 102. In response to a request from GUI host 107, reduced template definition object 120 may be processed by template expand application 128 to generate an expanded template definition object 130 that may be stored within host storage 136 and accessed and provisioned to client node 111 by a template server 109.

After expansion, template definition object 130 retains prototype table 122 and includes an expanded UI template object 134. Specifically, template expand application 128 reads the PTABLE REF reference within the TABLE_2 structure element of reduced UI template 124. In response, template expand application 128 inserts the display elements CELL_2, CELL_3, CELL_4, and CELL_5 that are defined (but not expressly depicted) within the ROW_2 element within prototype table 122. The expanded UI template 134 can be displayed such as via a browser program and display device 115 within client node 111.

As depicted, template expand application 128 constructs expanded UI template 134 to include all of the structure and display elements that were included in the reduced UI code 124. In addition, template expand application 128 includes code for reading structure elements within reduced template code 124 to identify or otherwise determine whether one or more of the structure elements contain a reference to prototype table 122. For instance, template expand application 128 reads the TABLE_2 element to identify and read the PTABLE REF reference element that is logically associated with prototype table 122 by the incorporation of an ID for prototype table 122 (e.g., TABLE_PROTOTYPE) within the PTABLE REF reference element. Having identified prototype table 122, template expand application 128 copies intra-level display property patterns from prototype table 122 into the structure element instance, TABLE_2. As shown, the result is that four additional cell elements, CELL_2, CELL_3, CELL_4, and CELL_5 are inserted within the ROW_2 row element of TABLE_2.

FIGS. 2A-2C illustrate a hierarchical XML template definition object represented as including an expanded template object in accordance with some embodiments. FIG. 2D is a block diagram depicting an XML tree representing hierarchically related markup language elements corresponding to the expanded template object and associated markup language elements within a prototype table shown in FIGS. 2A-2C. Referring to FIG. 2D in conjunction with FIGS. 2A-2C, a template definition object 240 includes at a highest hierarchical level an expanded template 220 and a prototype table 202. As shown in FIG. 2A, template definition object 240 is defined as a root XML element<templatehierarchy assigned a version 3.0. As shown in FIG. 2C, expanded template object 220 has an assigned ID (templateName) “Starter Template.” Incorporated within Starter Template 220 is a container element 222 having an assigned ID (name) “first level container” and itself including two child XML container elements “Profile” 224 and “tables” 226. The Profile container element 224 includes a display field element 227 that itself is a display property element of container structure element 226 and incorporates display property elements <name> and <label>. As shown in FIG. 2C, the <name> display property element (ID value) is assigned “profilename” and <label> is assigned “Profile Name.”

The tables container element 226 includes a child container element 228 having an assigned “inside_tables” name/ID and including a display field element <fields> having <name> “someText” and <label> “Some value.” Container element 226 further includes an XML table structure element 230 having an assigned “Table” name/ID. Table element 230 itself includes a reference element 225 and a row-type structure element 232 having an assigned <name> set to “some_row.” Reference element 225 is a reference to a prototype structure element represented in the depicted embodiment as prototype table 202. As shown in FIG. 2C, reference element 225 comprises a prototype identifier element <prototype> that is assigned reference value “starter_table_prototype” that corresponds to name ID element of prototype table 202.

As depicted and described with reference to FIG. 1, prototype table 202 is generated based on intra-level (i.e., within respective hierarchical levels) display property pattern matching. For the embodiment depicted in FIGS. 2A-2D, the parsing and pattern matching results in display property patterns (i.e., repetition of display properties) that are identified or otherwise determined and incorporated within prototype table column elements 204, 206, 208, 210, and 212. For instance, and referring to FIG. 2A, column element 204 defines a field value “foo” having type textstring and length 5 and label “Starter label” as being the default value for the prototype table field value corresponding to <columnname>“column_1.” Column element 206 defines an empty field (e.g., spacer field type) such as may be used as the default corresponding to the field value corresponding to <columnname>“column_8 and used for generating an empty column when utilized to expand the reduced version of starter template 220. To this end, the value element for column 206 is set to null. The field values in each of column elements 204 and 206 are included in prototype table 202 to replace otherwise repeated display property instances (i.e., repeated text boxes containing “foo”) within a reduced template definition object.

Similar to elements 204 and 206, column elements 208, 210, and 212 are configured within the prototype table to preserve a single, referenceable instances of field display properties within template definition object 240. More specifically, column elements 208, 210, and 212 are configured and utilized to replace multiple checkboxes for alarms and QoS enablement with a combination box (i.e., box that present multiple selectable options). As shown in FIG. 2A, column element 208 has a <type> display element set to combobox and <columnname> display element set to “enablecombo.” Column element 208 further includes four field element <values> having <displayvalue> elements set to “QoS,” “QoS and Alarms,” “Alarm,” and “None.” Column elements 210 and 212 have <type> display elements each set to “checkbox” and <columnname> display elements set to “sendQoS” and “sendAlarm,” respectively. In the depicted prototype table configuration, the combobox defined within column element 208 is displayed in place of the Alarm and QoS enablement checkboxes by virtue of the <hidden> display property element being set to “false” for column 208 and “true” for columns 210 and 212.

Prototype table 202, referenced by the reference element 225 within template Table 230, further comprises two row-type structure elements 214 and 216 (depiction of row 216 omitted from FIG. 2D to avoid overcrowding of illustration). Row 214 is an override row for overriding one or more display properties/attributes that are specified in the display property patterns contained within the column elements. While depicted as part of prototype table 202, alternate embodiments may configure a reduced template code set to include override row 214. As shown in FIG. 2B, override row 214 includes a <name> element set to “first_row” and cell field elements 205, 207, 209, and 211 that incorporate the field values of columns 206, 208, 210, and 212 based on columname references within each of the respective cells. Specifically, cell elements 205, 207, 209, and 211 include <columnname> reference elements that specify “column_8,” “enablecombo,” “sendQos,” and “sendAlarm,” respectively. Row 214 further includes an override cell 203 that includes <columnname> column_1 reference and a field property override <type> of “checkbox” to replace the “textstring”<type> element within column element 204. Override cell 203 further include a field override <label> of “Active” to replace the “Starter label”<label> element within column element 204. As shown in FIG. 2B (omitted from FIG. 2D), row 216 has a distinct row name “second_row” but does not override any of the prototype column definitions.

For the embodiment depicted in FIGS. 2A-2D, the some_row row element 232 is an override element that is included in a reduced version of the expanded template 220 (e.g., equivalent of reduced UI template 124 in FIG. 1). The override function is implemented by one or more of five cell elements that are incorporated within row element 232. The cell elements include four cells 234 having field values specified by respectively designated column structure elements that are defined within prototype table 202 (i.e., field values specified within columns 206, 208, 210, and 212). The field values are associated via reference element 225 to display properties specified within prototype table 202. The cell elements further include an override cell element 229 that overrides the prototype-specified field value of “foo” with “42.”

FIG. 2E illustrates a displayed graphical interface 252 generated by rendering the template definition object shown in FIGS. 2A-2C. The depicted components of graphical interface 252 are displayed by a display application such as a browser that reads the XML code and displays corresponding display objects accordingly. Graphical interface 252 is bounded by an outer box 254 having a caption “CAPTION” that are specified by first level container 222. Within outer container box 254 are display objects corresponding to container, table, column, and row structural elements. For instance, a container object 256 corresponds to the “Profile” container element 224 and its constituent “Profile Name” field 227.

Others of the displayed objects correspond to structure elements and corresponding display property elements within the tables container element 226. For example, display object 260 corresponds to the display field within the inside-tables container element. Display objects 262, 264, and 266 correspond to column and row elements configured within prototype table 202 as well as override elements included in a reduced version of starter template 220. For example, display objects 262, 264, and 266 include leftmost oriented fields 268a, 268b, and 268c, respectively, that correspond to the prototype column_1 element at least in terms of being mutually vertically aligned within the display. As shown, field 268a within object 262 includes a displayed label “Active” and field type (checkbox) corresponding to the override cell 203. Field 268b within object 264 includes a displayed label “Starter label,” field type (textstring) and value “foo” corresponding to the column_1 204 element definition. Field 268c within object 266 includes the default column_1 displayed label “Starter label” as well as the default column_1 field type (text box) both of which are retained by override cell 229. The default field value of “foo” is replaced with “42” in accordance with the override field value within override cell 203. As depicted, fields 270a, 270b, and 270c correspond to the column_8 (empty column) default element settings which are not overridden in any of display objects 262, 264, and 266. Each of fields 272a, 272b, and 272c correspond to the enablecombo column element 208 with the respective labels determined in accordance with the respective rownames.

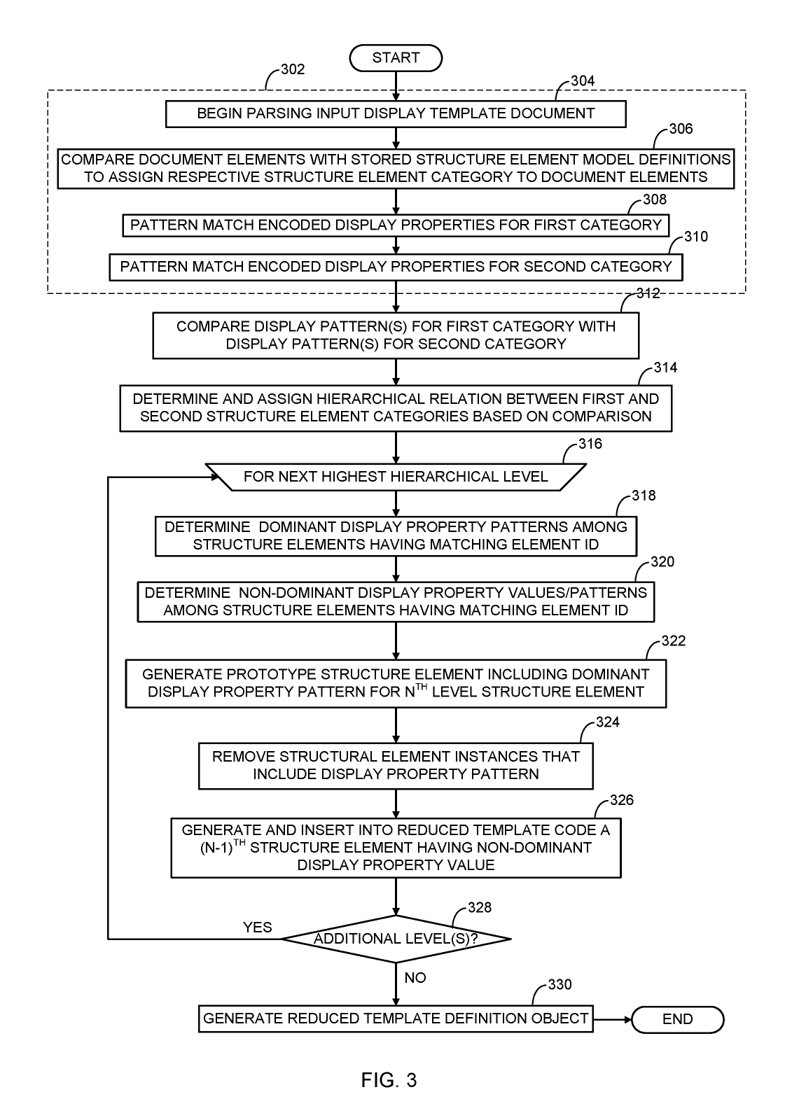

FIG. 3 is a flow diagram depicting operations and functions for reducing markup language graphical interface constructs in accordance with some embodiments. The operations, functions, and code constructs depicted and described with reference to FIG. 3 may be performed or embodied by any one or more of the systems, components, and code constructs depicted and described with reference to FIGS. 1 and 2A-2E. The process begins as shown at superblock 302 with a parsing process to identify or otherwise determine display property patterns for elements within a template object, such as a template file/document. For instance, in some embodiments, a template object may be input to and processed by a template reduce application that includes a pattern match module that begins parsing elements within the document (block 304). As part of the overall parsing processing, the pattern match module may compare document elements (e.g., XML elements) within the template to storage structure element model definitions (block 306). The model definitions may comprise text strings representing IDs for various structure elements such as “container,” “table,” “column,” “row,” etc. The comparisons and result of the comparisons may be utilized by the pattern match module to assign respective structure element categories to the identified document elements. In another embodiment, the pattern match module may parse the document elements to find matching position-related information. For example, the pattern match module may categorize multiple detected checkboxes as being included in a same “column” based on the relative positioning of the checkboxes as determined by element display properties (i.e., display property positioning information indicating that the checkboxes are vertically aligned when rendered on a display).

The process continues as shown at blocks 308 and 310 with processing the data to determine a “dominant” display pattern structure. For example, many displayed interfaces may include stronger patterns in one display dimension (e.g., columnar) than in the other (e.g., row-wise). In some embodiments, the pattern match module determines display property patterns for at least two structure elements categories as shown at blocks 308 and 310 and compares display property patterns (block 312) to determine which structure element category (e.g., column or row) will be higher or lower with respect to the other. For instance, the hierarchical levels of structure elements may include a parent level comprising structure elements that define fields arranged in a first display dimension and a child level comprising structure elements that define fields arranged in a second display dimension. At block 314, the template reduce application may determine the parent child hierarchical relation between the parent level and the child level based, at least in part, on comparing display property patterns among fields arranged in the first display dimension (e.g., columnar) and display patterns among fields arranged in the second display dimension (e.g., row-wise). This determination effectively determines the manner in which the different structure element categories are used in combination to reduce and expand template documents.

In addition to dominance in terms of which display dimension includes more pattern occurrences, the template reduce application determines dominance of recurrence/repetition of display properties and display property values to determine with patterns to include in a prototype structure element. Beginning at block 316, the template reduce application iterates in hierarchical sequence through each of the levels to generate one or more prototype structure elements. At block 318, the template reduce application determines dominant display property patterns among structure elements that each have a common or otherwise matching element ID. In addition to identifying dominant patterns, the template reduce application also determines exceptions to those patterns in the form of non-dominant display property values or patterns (block 320).

At block 322, the template reduce application generates one or more prototype structure elements, each corresponding to a respectively identified pattern over a given display dimension in an N^{th} level structure element (e.g., column level). In its direct code reduction function, the template reduce application removes one or more of all of the instances of the identified patterns from the template document to form a reduced template code object (block 324). At block 326, the template reduce application generates an (N−1)^{th} level structure element (e.g., row) having one of the identified non-dominant (i.e., exception) display property values and inserts the exception structure element into the reduced template code. The prototype structure and reduced template code continues to cycle with control passing from block 328 to block 316 until each of the hierarchical levels have been processed. The template reduce application then generates a reduced template definition object that includes the prototype structures and the reduced template code (block 330) and the process ends.

FIG. 4 is a flow diagram illustrating operations and functions for rendering expanded graphical interface code in accordance with some embodiments. The operations and functions and code constructs depicted and described with reference to FIG. 4 may be performed or embodied by any one or more of the systems, components, and code constructs depicted and described with reference to FIGS. 1 and 2A-2E. The process begins as shown at block 402 with a template expand application reading a next structure element, such as an XML table element within reduced template code. In response to determining that the structure element includes a prototype structure element reference, the template expand application copies an intra-level display property pattern from the prototype structure element into a structure element instance of an expanded template object (blocks 404 and 406). For example, in reading the properties and sub-elements of a table element in the reduced template, the expand application may read a prototype reference element that specifies a prototype table ID. The expand application may then read the identified prototype table element within the overall reduced template definition object and copy display property patterns such as in the form of column sub-elements within the prototype table into the template structure element.

The expand function cycles with control passing from block 408 to block 402 until an expanded template code object has been generated. Control then passes to block 410 with the expanded template object being stored within a host server system such as GUI host 107 in FIG. 1. At block 412, a client node, node such as client node 111 in FIG. 1, receives and reads the expanded template object in response to a template request from the client host server to the host server. The process concludes with a template object reader, such as browser 113 in FIG. 1, rendering a display object corresponding to the expanded template object (block 414).

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality provided as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

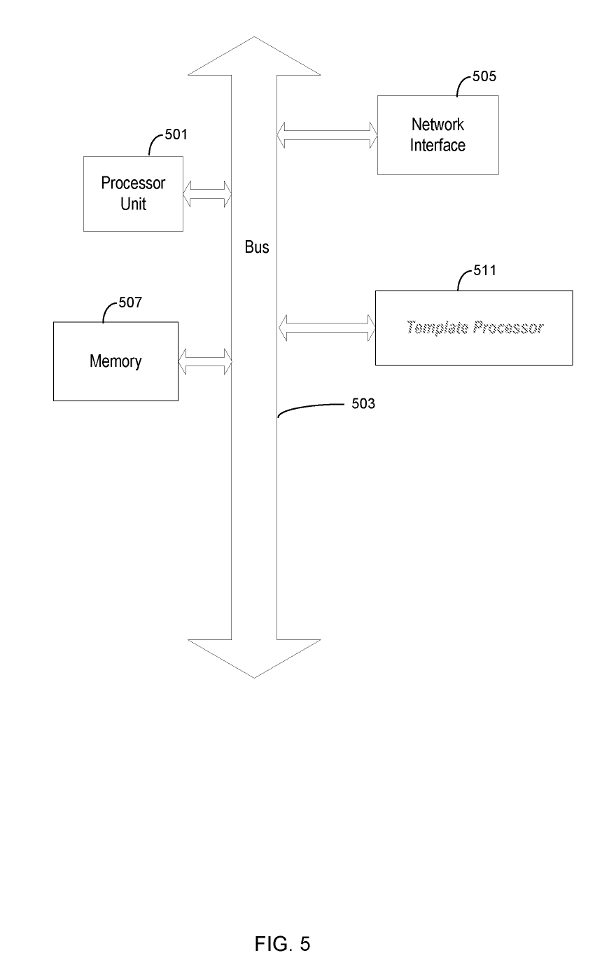

FIG. 5 depicts an example computer system that implements template reduction, expansion, and rendering in accordance with an embodiment. The computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport® bus, InfiniBand® bus, NuBus, etc.) and a network interface 505 (e.g., a Fiber Channel interface, an Ethernet interface, an internet small computer system interface, SONET interface, wireless interface, etc.). The system also includes a template processor 511. The template processor 511 provides program structures for reducing, expanding, and rendering template objects as described with reference to FIGS. 1-4. To this end, the template processor 511 may incorporate some or all of the system, devices, and components described in FIG. 1.

Any one of the previously described functionalities may be partially (or entirely) implemented in hardware and/or on the processor unit 501. For example, the functionality may be implemented with an application specific integrated circuit, in logic implemented in the processor unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501 and the network interface 505 are coupled to the bus 503. Although illustrated as being coupled to the bus 503, the memory 507 may be coupled to the processor unit 501.

While the aspects of the disclosure are described with reference to various implementations and exploitations, it will be understood that these aspects are illustrative and that the scope of the claims is not limited to them. In general, techniques for an object storage backed file system that efficiently manipulates namespace as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality shown as separate components in the example configurations may be implemented as a combined structure or component. Similarly, structures and functionality shown as a single component may be implemented as separate components. These and other variations, modifications, additions, and improvements may fall within the scope of the disclosure.

1. A method comprising:
within a template object that contains hierarchical levels of structure elements describing a display object, parsing code to determine an intra-level display property pattern for structure elements within at least one of the hierarchical levels, wherein the hierarchical levels include a parent level comprising structure elements that define fields arranged in a first display dimension and a child level comprising structure elements that define fields arranged in a second display dimension;
determining a parent child hierarchical relation between the parent level and the child level based, at least in part, on comparing display property patterns among fields arranged in the first display dimension to display property patterns among fields arranged in the second display dimension, wherein the parent level comprises column elements and the child level comprises rows elements;
generating a prototype structure element that includes the determined intra-level display property pattern, said generating a prototype structure element including generating a prototype table element comprising a column element that includes the determined intra-level display property pattern;
generating a template definition object that includes,
the prototype structure element; and
reduced template code that is a subset of the code within the template object, wherein the reduced template code includes at least one structure element that contains a reference to the prototype structure element;
parsing code within the template definition object to determine a structure element display property that does not match the intra-level display property pattern;
including in the reduced template code a row element that includes the structure element display property that does not match the intra-level display property pattern; and
in response to reading the template definition object, expanding the reduced template code in accordance with the reference to generate an expanded template object.

2. The method of claim 1, further comprising displaying the display object including executing a template display program that receives the expanded template object as input.

3. The method of claim 1, wherein said expanding comprises:
reading structure elements within the reduced template code; and
in response to reading the at least one structure element that references the prototype structure element, copying the intra-level display property pattern from the prototype structure element into an instance of the at least one structure element.

4. The method of claim 1, wherein said parsing code to determine the intra-level display property pattern comprises for each of at least two structure elements having matching element identifiers, pattern matching display property fields within the at least two structure elements.

5. The method of claim 1, wherein the hierarchical levels of structure elements include a parent level and a child level, and wherein the parent level structure elements specify field values in association with respective parent level structure element names, and wherein the child level structure elements specify field values in association with child level structure element names and at least one of the parent level structure element names.

6. (canceled)

7. (canceled)

8. (canceled)

9. The method of claim 1, wherein said generating the template definition object comprises referencing the prototype structure element within the reduced template code by inserting a prototype reference sub-element within a structural element of the reduced template code.

10. The method of claim 1, wherein said generating the template definition object further comprises removing, from the template object, instances of structural elements that include display properties matching the determined intra-level display property pattern.

11. The method of claim 1, wherein said expanding the reduced template code comprises:
parsing the reduced template code to locate, within each of the at least one structure element that references the prototype structure element, a reference element that specifies an identifier of the prototype structure element; and
inserting one or more structure sub-elements within each of the at least one structure element, wherein each of the one or more structure sub-elements are configured based on display property elements defined for a respective prototype structure element corresponding to the specified identifier.

12. The method of claim 1, wherein said determining an intra-level display property pattern includes:
for each of at least one of the hierarchical levels, determining a set of structure elements that each have a same element type; and
for each of at least one of the hierarchical levels, comparing display properties among the set of structure elements to determine a display property pattern.

13. One or more non-transitory machine-readable media comprising program code for configuring template objects, the program code to:
within a template object that contains hierarchical levels of structure elements describing a display object, parse code to determine an intra-level display property pattern for structure elements within at least one of the hierarchical levels, wherein the hierarchical levels include a parent level comprising structure elements that define fields arranged in a first display dimension and a child level comprising structure elements that define fields arranged in a second display dimension;
determine a parent child hierarchical relation between the parent level and the child level based, at least in part, on comparing display property patterns among fields arranged in the first display dimension to display property patterns among fields arranged in the second display dimension, wherein the parent level comprises column elements and the child level comprises row elements;
generate a prototype structure element that includes the determined intra-level display property pattern, said generating a prototype structure element including generating a prototype table element comprising a column element that includes the determined intra-level display property pattern;
generate a template definition object that includes,
the prototype structure element; and
reduced template code that is a subset of the code within the template object, wherein the reduced template code includes at least one structure element that contains a reference to the prototype structure element;
parse code within the template definition object to determine a structure element display property that does not match the intra-level display property pattern;
include in the reduced template code a row element that includes the structure element display property that does not match the intra-level display property pattern; and
in response to reading the template definition object, expand the reduced template code in accordance with the reference to generate an expanded template object.

14. The machine-readable media of claim 13, wherein the program code to expand the reduced template code includes program code to:
read structure elements within the reduced template code; and
in response to reading the at least one structure element that references the prototype structure element, copy the intra-level display property pattern from the prototype structure element into an instance of the at least one structure element.

15. (canceled)

16. (canceled)

17. (canceled)

18. The machine-readable media of claim 13, wherein the program code to determine an intra-level display property pattern includes program code to:
for each of at least one of the hierarchical levels, determine a set of structure elements that each have a same element type; and
for each of at least one of the hierarchical levels, compare display properties among the set of structure elements to determine a display property pattern.

19. (canceled)

20. (canceled)
